(19) United States
(12) Patent Application Publication
(10) Pub. No.: US 2021/0274774 A1
(43) Pub. Date: Sep. 9, 2021

(54) CONTROL METHOD FOR AGRICULTURAL MECHANICAL DEVICE AND AGRICULTURAL MECHANICAL DEVICE

(71) Applicant: SZ DJI TECHNOLOGY CO., LTD., Shenzhen (CN)

(72) Inventors: Guoxiu PAN, Shenzhen (CN); Zijing CHANG, Shenzhen (CN); Guang YAN, Shenzhen (CN)

(21) Appl. No.: 17/327,383

(22) Filed: May 21, 2021

Related U.S. Application Data
(63) Continuation of application No. PCT/CN2018/117247, filed on Nov. 23, 2018.

(51) Int. Cl. A01M 7/00; B64D 1/18

(52) U.S. Cl. CPC A01M 7/0089; B64C 39/024; B64D 1/18

(57) ABSTRACT

A control method includes obtaining a linear speed of one operation member of a plurality of operation members of an agricultural mechanical device when the agricultural mechanical device is making a curvilinear movement, determining an operation rate of the one operation member according to the linear speed of the one operation member, and controlling the one operation member to perform an operation according to the operation rate of the one operation member. The plurality of operation members are located at different positions in a direction perpendicular to a moving direction of the agricultural mechanical device.

### CROSS-REFERENCE TO RELATED APPLICATION

This application is a continuation of International Application No. PCT/CN2018/117247, filed Nov. 23, 2018, the entire content of which is incorporated herein by reference.

### TECHNICAL FIELD

The present disclosure relates to the field of electronic device and, in particular, to a control method for agricultural mechanical device and an agricultural mechanical device.

### BACKGROUND

With continuous development of agricultural modernization and precision agriculture, mechanized agriculture has been vigorously promoted, and the vigorous development of agricultural mechanical device has greatly improved efficiency of agricultural production. For example, in a process of an agricultural operation, an agricultural unmanned aerial vehicle, a tractor-equipped agricultural mechanical device, or a self-propelled agricultural mechanical device, etc., can be used to perform a task, such as pesticide spraying, fertilization, or seeding, thereby liberating labor and improving operate efficiency.

To improve operation efficiency, when an agricultural mechanical device performs a task, such as pesticide spraying, fertilization, or seeding, a plurality of operation members, such as a plurality of nozzles or a plurality of distribution outlets, are usually used simultaneously. Each operation member performs an operation at a same operation rate. That is, the plurality of spraying nozzles perform spraying operations at a same spraying rate, or the plurality of discharge outlets perform operations at a same distribution rate. Therefore, when the agricultural mechanical device turns during operation, respraying or redistribution may occur on an inner side of the turn, and missing spraying or missing distribution may occur on an outer side of the turn, which may cause the agricultural mechanical device to operate unevenly during the turn and have a poor operation result.

### SUMMARY

In accordance with the disclosure, there is provided a control method including obtaining a linear speed of one operation member of a plurality of operation members of an agricultural mechanical device when the agricultural mechanical device is making a curvilinear movement, determining an operation rate of the one operation member according to the linear speed of the one operation member, and controlling the one operation member to perform an operation according to the operation rate of the one operation member. The plurality of operation members are located at different positions in a direction perpendicular to a moving direction of the agricultural mechanical device.

Also in accordance with the disclosure, there is provided a control method including obtaining speed information of the agricultural mechanical device making a curvilinear movement, determining operation rates of a plurality of operation members of the agricultural mechanical device according to the speed information, and controlling the plurality of operation members to perform operations at the operation rates of the plurality of operation members. The plurality of operation members are located at different positions in a direction perpendicular to a moving direction of the agricultural mechanical device.

### BRIEF DESCRIPTION OF THE DRAWINGS

FIG. 1A is a schematic architecture diagram of an example unmanned aerial system consistent with the embodiments of the present disclosure.

FIG. 1B is a schematic structural diagram of the unmanned aerial system consistent with embodiments of the present disclosure.

FIG. 2 is a schematic flow chart of a control method for an agricultural mechanical device according to an example embodiment of the disclosure.

FIG. 3 is a schematic diagram showing an application of the agricultural mechanical device control method according to an example embodiment of the disclosure.

FIG. 4 is a schematic flow chart of a control method for an agricultural mechanical device according to another example embodiment of the disclosure.

FIG. 5 is a schematic structural diagram of an example agricultural mechanical device according to an embodiment of the disclosure.

FIG. 6 is a schematic structural diagram of another example agricultural mechanical device according to another embodiment of the disclosure.

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

As used herein, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed.

Some implementation manners of the present disclosure are described in detail below with reference to the drawings. When there is no conflict, the following embodiments and features of the embodiments may be combined with each other.

A control method for agricultural mechanical device and an agricultural mechanical device are provided in the embodiments of the present disclosure. The agricultural mechanical device includes, but is not limited to, an agricultural aerial mechanical device and an agricultural land mechanical device, for example, an agricultural unmanned aerial vehicle (UAV), an autonomous operation robot, a tractor-equipped agricultural mechanical device, or a self-propelled agricultural mechanical device, etc. The agricultural UAV may include a rotorcraft, for example, a multi-rotor aircraft propelled by a plurality of propulsion devices through the air, which is not limited here.

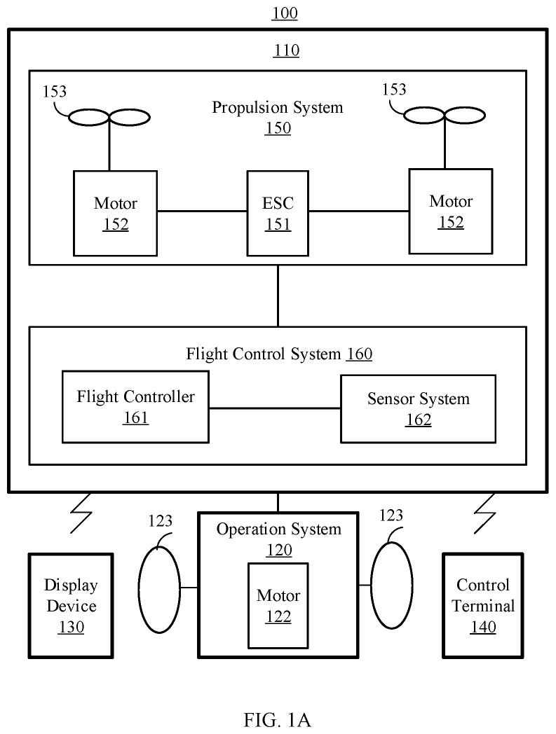

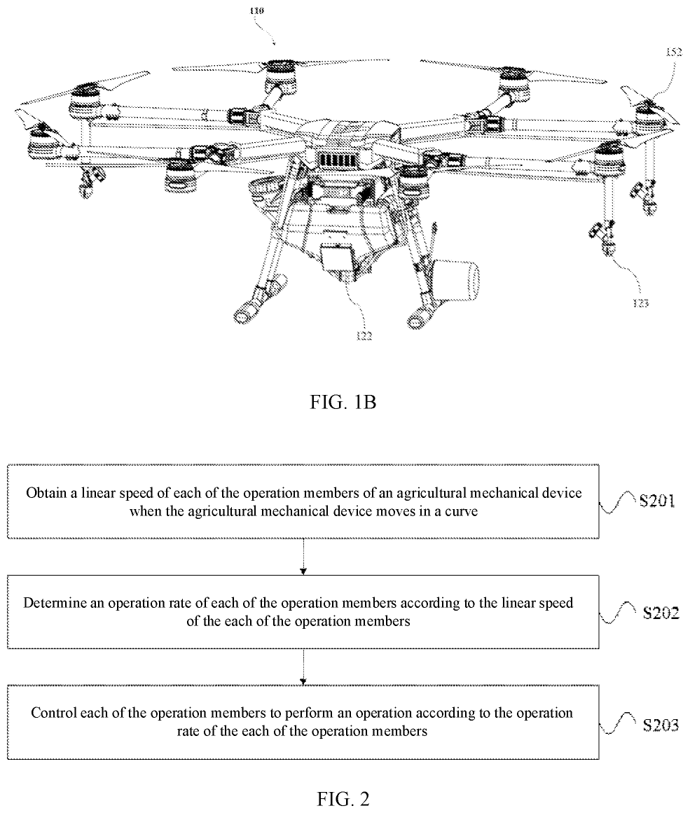

FIG. 1A is a schematic architecture diagram of an example unmanned aerial system 100 consistent with the embodiments of the present disclosure. FIG. 1B is a schematic structural diagram of the unmanned aerial system 100 consistent with embodiments of the present disclosure. As shown in FIG. 1A and FIG. 1B, in an example embodiment, a rotor UAV is taken as an example for description.

The unmanned aerial system 100 includes a UAV 110, a display device 130, and a control terminal 140. The UAV 110 includes a propulsion system 150, a flight control system 160, a frame, and an operation system 120 arranged at the frame. The UAV 110 may wirelessly communicate with the control terminal 140 and the display device 130.

The frame may include a vehicle body and a stand (also called a landing gear). The vehicle body may include a central frame, one or more vehicle arms connected to the central frame, and the one or more vehicle arms extend radially from the central frame. The stand is connected to the vehicle body and used to support the UAV 110 for landing.

The propulsion system 150 includes one or more electronic speed controllers (ESCs) 151, one or more propellers 153, and one or more motors 152 corresponding to the one or more propellers 153. The motor 152 is connected between the electronic speed controller 151 and the propeller 153, and the motor 152 and propeller 153 are arranged at the vehicle arm of the UAV 110. The electronic speed controller 151 is used to receive a driving signal generated by the flight control system 160, and supply driving current to the motor 152 to control the speed of the motor 152 according to the driving signal. The motor 152 is used to drive the propeller 153 to rotate, thereby providing power for the flight of the UAV 110, which enables the UAV 110 to achieve one or more degrees of freedom of movement. In some embodiments, UAV 110 may rotate around one or more rotation axes. For example, the rotation axis may include a roll axis, a yaw axis, and a pitch axis. The motor 152 may be a direct current (DC) motor or an alternating current (AC) motor. In addition, the motor 152 may be a brushless motor or a brushed motor.

The flight control system 160 includes a flight controller 161 and a sensor system 162. The sensor system 162 is used to measure attitude information of the UAV, that is, position information and status information of the UAV 110 in space, such as three-dimensional position, three-dimensional angle, three-dimensional velocity, three-dimensional acceleration, and three-dimensional angular speed, etc. The sensor system 162 may include, for example, at least one of sensors such as a gyroscope, an ultrasonic sensor, an electronic compass, an inertial measurement unit (IMU), a vision sensor, a global navigation satellite system receiver, and a barometer. For example, the global navigation satellite system may be the global positioning system (GPS). The flight controller 161 is used to control the flight of the UAV 110. For example, the flight of the UAV 110 may be controlled according to the attitude information measured by the sensor system 162. The flight controller 161 may control the UAV 110 according to pre-programmed program instructions and may control the UAV 110 by responding to one or more control instructions from the control terminal 140.

The operation system 120 may include one or more propulsion units 122. The operation system 120 may also include a plurality of operation members 123 to perform agricultural operations. The propulsion unit 122 may provide operation power for the operation members 123. The flight controller 161 may control the movement of the operation system 120 through the propulsion unit 122. In another example embodiment, the operation system 120 may also include a controller used to control the movement of the operation system 120 through the propulsion unit 122. The operation system 120 may be separated from the UAV 110 or be a part of the UAV 110. The propulsion unit 122 may be a DC propulsion unit or an AC propulsion unit. For example, the propulsion unit 122 may be a motor, a cylinder, or a water pump. The operation member 123 may be located on the top of the UAV, or on the bottom of the UAV. The operation member 123 may include a spraying nozzle, a distribution outlet, etc.

The plurality of operation members 123 may be directly fixed at the UAV 110, therefore the operation system 120 may be omitted.

The display device 130 is located at the ground terminal of the UAV 100, may communicate with the UAV 110 in a wireless manner, and may be used to display the attitude information of the UAV 110. In addition, the image shot by the image device may also be displayed on the display device 130. The display device 130 may be a separate device or integrated in the control terminal 140.

The control terminal 140 is located at the ground terminal of the UAV 100 and may communicate with the UAV 110 in a wireless manner for remote control of the UAV 110.

The above naming of the components of the unmanned aerial system is only for identification purposes and should not be understood as a limitation to the embodiments of the present disclosure. For example, a following control method for an agricultural mechanical device may be applied to control the plurality of operation members to perform an operation.

FIG. 2 is a schematic flow chart of the control method for an agricultural mechanical device according to an example embodiment of the disclosure. The method can be used to control an agricultural mechanical device to perform an agricultural operation. The agricultural mechanical device may be provided with a plurality of operation members, and the plurality of operation members are located at different positions in a direction perpendicular to a moving direction of the agricultural mechanical device. As shown in FIG. 2, the control method for an agricultural mechanical device includes following processes.

At S201, a linear speed of each of the operation members of the agricultural mechanical device is obtained when the agricultural mechanical device moves in a curve (i.e., makes a curvilinear movement).

At S202, an operation rate of each of the operation members is determined according to the linear speed of the each of the operation members.

At S203, each of the operation members is controlled to perform an operation according to the operation rate of the each of the operation members.

The operation member is a component used to, for example, spray liquid or gas pesticides, spray liquid or gas fertilizers, or distribute solid pesticides, fertilizers, or seeds, during an agricultural operation.

When the agricultural mechanical device moves in a straight line, the linear speed of each of the operation members is same as each other, which is equal to a moving speed of the agricultural mechanical device.

When the agricultural mechanical device moves in a curve, the angular speed of each of the operation members is same as each other, which is equal to the angular speed of the agricultural mechanical device. However, because a turning radius of each of the operation members is different from each other, the linear speed of each of the operation members is different from each other. The operation member located on an inner side of the turn has a relatively small turning radius, thus the linear speed is relatively small. The operation member located on an outer side of the turn has a relatively large turning radius, thus the linear speed is relatively large.

In some embodiments, the linear speed of each of the operation members can be obtained by mounting a motion sensor at each of the operation members. Alternately, the linear speed of each of the operation members can also be determined according to speed information of the agricultural mechanical device.

The operation rate can be expressed in terms of a mass or volume of the sprayed or distributed operation material per unit time, and the unit can be in liters per second (L/s), milliliters per second (mL/s), kilograms per second (kg/s), or grams per second (g/s), etc.

When an effective operation width of the operation member is determined, an operation area per unit time is positively related to the linear speed of the operation member. Generally, a total amount of operation material expected to be sprayed or distributed per unit area is predetermined. To achieve uniform operation, the total amount of operation material expected to be sprayed or distributed per unit time is positively related to the operate area of the operation material per unit time. Therefore, the operation rate of the operation member is positively related to the linear speed of the operation member.

In an example embodiment, a relatively small operation rate is determined for the operation member with a relatively small linear speed on the inner side of the turn, to prevent respraying and redistribution on the inner side of the turn when the agricultural mechanical device moves in a curve. A relatively large operation rate is determined for the operation member with a relatively large linear speed on the outer side of the turn, to prevent missing spraying or missing distribution on the outer side of the turn when the agricultural mechanical device moves in a curve.

In an example embodiment, when the linear speed of the operation member is increased, the operation rate of the operation member can be increased to prevent missing spraying or missing distribution. When the linear speed of the operation member is reduced, the operation rate of the operation member can be reduced to prevent respraying or redistribution.

In an example embodiment, after the operation rate of each of the operation members is determined, each of the operation members is controlled to perform an operation at the determined operation rate.

In the control method for an agricultural mechanical device consistent with the embodiments, the linear speed of each of the operation members of the agricultural mechanical device is obtained when the agricultural mechanical device moves in a curve. The operation rate of each of the operation members is determined according to the linear speed of the each of the operation members. Each of the operation members is controlled to perform an operation according to the operation rate of the each of the operation members. The operation rate of each of the operation members is adaptively determined according to the linear speed of the each of the operation members, which enables the agricultural mechanical device to operate evenly when the agricultural mechanical device moves in a curve, thereby improving an operation effect and solving a problem that an existing agricultural mechanical device operates unevenly when the existing agricultural mechanical device moves in a curve, which has a poor operation effect.

In some embodiments, one implementation manner to obtain the linear speed of each of the operation members of the agricultural mechanical device when the agricultural mechanical device moves in a curve may include obtaining the linear speed of each of the operation members of the agricultural mechanical device according to a preset operation route and current position information of the agricultural mechanical device.

When agricultural mechanical device performs an autonomous operation, for example, an operation route is planned through a control station or a control terminal, etc. The preset operation route may include the position information of each point in the operation route. The position information may use absolute position information, such as longitude and latitude information, or relative position information, such as a distance and a bearing indication relative to a starting point of the operation route.

In some embodiments, the current position information of the agricultural mechanical device can be obtained, for example, through a positioning system mounted at the agricultural mechanical device. The positioning system can, for example, use the Global Positioning System (GPS), BeiDou satellite positioning system, Real-Time Kinematic (RTK) positioning system, etc.

In some embodiments, according to the preset operation route and the current position information of the agricultural mechanical device, it can be determined whether the agricultural mechanical device moves in a straight line or a curve. When the agricultural mechanical device moves in a curve, a current turning radius of the agricultural mechanical device can also be determined according to the preset operation route, and then the linear speed of each of the operation members of the agricultural mechanical device can be obtained.

In some embodiments, one implementation manner to obtain the linear speed of each of the operation members of the agricultural mechanical device according to the preset operation route and the current position information of the agricultural mechanical device may include determine a turning radius of the agricultural mechanical device according to the preset operation route and the current location information of the agricultural mechanical device, and obtaining the linear speed of each of the operation members of the agricultural mechanical device according to the turning radius and a current moving speed of the agricultural mechanical device, and a distance of the each of the operation members from a central axis of the agricultural mechanical device.

After the current position information of the agricultural mechanical device is determined, a specific position of the agricultural mechanical device in the preset operation route can be determined according to the preset operation route. If the agricultural mechanical device moves in a curve at this time, then the turning radius of agricultural mechanical device can be determined.

In some embodiments, the distance between each of the operation members and the central axis of the agricultural mechanical device can be determined according to one or more device parameters of the agricultural mechanical device, or can be obtained by a measurement, which is not limited here.

In some embodiments, the current moving speed of the agricultural mechanical device may be a current moving linear speed or a current moving angular speed, which can be obtained by a linear speed sensor or an angular speed sensor mounted at the agricultural mechanical device.

In some embodiments, one implementation manner to obtain the linear speed of each of the operation members of the agricultural mechanical device according to the turning radius and the current moving speed of the agricultural mechanical device, and the distance of the each of the operation members from the central axis of the agricultural mechanical device may include determining the angular speed of the agricultural mechanical device according to the turning radius and current moving speed of agricultural mechanical device, determining the turning radius of each of the operation members according to the turning radius of the agricultural mechanical device and the distance of the each of the operation members from the central axis of the agricultural mechanical device, and obtaining the linear speed of each of the operation members of the agricultural mechanical device according to the turning radius of the each of the operation members and the angular speed of the agricultural mechanical device.

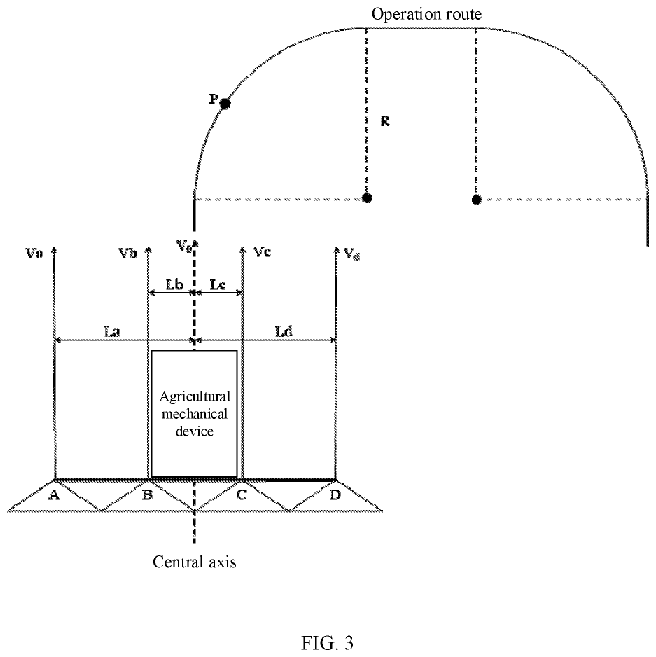

A specific example to describe the specific implementation method of obtaining the linear speed of each of the operation members of the agricultural mechanical device according to the preset operation route and the current position information of the agricultural mechanical device is as follows. FIG. 3 is a schematic diagram showing an application of the agricultural mechanical device control method according to an example embodiment of the disclosure. A part of the preset operation route is shown in an upper part of FIG. 3. As shown in FIG. 3, the agricultural mechanical device moves in a curve on a left side and a right side of the operation route, and moves in a straight line in a middle part of the operation route. A, B, C, and D represent four operation members, respectively. A triangular area represents an effective operation area of each of the operation members. The central axis of the agricultural mechanical device is shown by a dash line passing through the agricultural mechanical device in FIG. 3. The distances of the operation members from the central axis are La, Lb, Lc, and Ld, respectively. V₀, Va, Vb, Vc, and Vd are used to represent instantaneous linear speeds of agricultural mechanical device and four operation members, respectively. When the agricultural mechanical device moves in a straight line, V₀=Va=Vb=Vc=Vd.

If it is determined that the agricultural mechanical device is currently located at position point P shown in FIG. 3 according to the operation route shown in FIG. 3 and the obtained current position information of the agricultural mechanical device, and the agricultural mechanical device can be determined to be currently moving in a curve and the turning radius is R, then the current angular speed of the agricultural mechanical device is ω=V₀/R. The angular speeds of the four operation members are same as the current angular speed of the agricultural mechanical device, which are ω. The turning radius of the operation member A is (R+La), then the current linear speed of the operation member A is Va=ω*(R+La)=V₀*(R+La)/R. The turning radius of the operation member B is (R+Lb), then the current linear speed of the operation member B is Vb=ω*(R+Lb)=V0*(R+Lb)/R. The turning radius of the operation member C is (R− Lc), then the current linear speed of the operation member C is Vc=ω*(R−Lc)=V₀*(R−Lc)/R. The turning radius of the operation member D is (R−Ld), then the current linear speed of the operation member D is Vd=ω*(R−Ld)=V₀*(R−Ld)/R.

In some embodiments, one implementation manner to obtain the linear speed of each of the operation members of the agricultural mechanical device when the agricultural mechanical device moves in a curve may include obtaining attitude information of the agricultural mechanical device and obtaining the linear speed of each of the operation members of the agricultural mechanical device according to the attitude information.

In some embodiments, the attitude information may include one or more of a three-dimensional position, a three-dimensional angle, a three-dimensional velocity, a three-dimensional acceleration, and a three-dimensional angular speed of the agricultural mechanical device. The attitude information can be obtained by a sensor mounted at the agricultural mechanical device. The sensor includes but is not limited to a gyroscope, an ultrasonic sensor, an electronic compass, or an IMU.

In some embodiments, one implementation manner to obtain the linear speed of each of the operation members of the agricultural mechanical device according to the attitude information may include determining the angular speed and turning radius of the agricultural mechanical device according to the attitude information, and obtaining the linear speed of each of the operation members of the agricultural mechanical device according to the angular speed and turning radius of the agricultural mechanical device, and the distance of the each of the operation members from the central axis of the agricultural mechanical device.

The angular speed and the turning radius of the agricultural mechanical device when the agricultural mechanical device moves in a curve can be determined according to the attitude information of the agricultural mechanical device. The turning radius of each of the operation members can be determined according to the turning radius of the agricultural mechanical device and the distance of the each of the operation members from the central axis of the agricultural mechanical device. Because the angular speed of each of the operation members is same as the angular speed of the agricultural mechanical device when the agricultural mechanical device moves in a curve, then according to a relationship between the linear speed and the angular speed, it can be determined that the linear speed of each of the operation members is equal to a product of the turning radius of the each of the operation members and the angular speed of the agricultural mechanical device.

In some embodiments, one implementation manner to determine the operation rate of each of the operation members according to the linear speed of the each of the operation members may include determining the operation rate of each of the operation members according to the linear speed of the each of the operation members and a preset corresponding relationship between the linear speed and the operation rate.

In some embodiments, the preset corresponding relationship between the linear speed and the operation rate can be predetermined through an actual measurement or a theoretical derivation. The preset corresponding relationship between the linear speed and the operation rate can be stored in advance in the agricultural mechanical device, or can be sent to the agricultural mechanical device by a control console or a control terminal during an operation. Table 1 shows a preset corresponding relationship between the linear speed and the operation rate according to an example embodiment. It should be noted that the numerical values are only for illustration, which are not limited thereto.

TABLE 1

| Linear speed | Operation rate |
|---|---|
| 10 m/s | 30 mL/s |
| 11 m/s | 35 mL/s |
| 12 m/s | 40 mL/s |

For example, if it is determined that the linear speed of an operation member in the agricultural mechanical device is 10 m/s, it can be determined that the operation rate of the operation member is 30 mL/s.

When the linear speed of each of the operation members is determined according to the preset corresponding relationship between the linear speed and the operation rate, the operation rate of each of the operation members can be quickly and accurately determined, which ensures a uniform operation and improves operation efficiency.

In some embodiments, the operation rate of each of the operation members is positively related to the linear speed of the each of the operation members. That is, the operation member with a relatively large linear speed has a large operation rate, the operation member with a relatively small linear speed has a relatively small operation rate. The operation rate is increased when the linear speed of the operation member is increased, the operation rate is reduced when the linear speed of the operation member is reduced, to realize the operation rate of the operation member is adaptively changed according to the linear speed of the operation member.

In some embodiments, one implementation manner to determine the operation rate of each of the operation members according to the linear speed of the each of the operation members may include determining a linear speed ratio among the operation members according to the linear speed of the each of the operation members, and determining the operation rate of each of the operation members according to the linear speed ratio among the operation members.

In some embodiments, an operation rate ratio between two operation members is positively related to the linear speed ratio between the two operation members.

In some embodiments, the operation rate of each of the operation members may be determined according to the linear speed ratio among the operation members and the total operation rate of the agricultural mechanical device. The total operation rate of the agricultural mechanical device is equal to a sum of the operation rates of the plurality of operation members of the agricultural mechanical device.

If the total operation rate of the agricultural mechanical device is determined, the operation rate can be allocated to each of the operation members according to the linear speed ratio among the operation members. For example, when the total operation rate of agricultural mechanical device is 100 mL/s, and the linear speed ratio among three operation members included in the agricultural mechanical device is 30:34:36, the operation rates of the three operation members can be 30 mL/s, 34 mL/s, and 36 mL/s, respectively.

In some embodiments, the operation member may include a nozzle and/or a distribution outlet. When the operation material includes a liquid and/or a gas, the operation member may include a nozzle, for example, to spray liquid or gas pesticides, or liquid or gas fertilizers, etc. When the operation material includes a solid, the operation member may include a distribution outlet, for example, to distribute solid granular or powdered pesticides, or solid granular or powdered fertilizers, or to sow seeds, etc. When the operate material includes a solid, a liquid and/or a gas, the operation member may include a nozzle and a distribution outlet, for example, to sow seeds with the distribution outlet and spray liquid fertilizers with the nozzle simultaneously.

In some embodiments, if the operation member includes one or more nozzles, a spraying rate of each of one or more nozzles can be determined according to the linear speed of the each of one or more nozzles, and each of one or more nozzles can be controlled to perform an operation according to the spraying rate of the each of one or more nozzles.

In some embodiments, controlling each of one or more nozzles to perform an operation according to the spraying rate of the each of one or more nozzles may include controlling each of one or more nozzles to perform an operation by at least one of adjusting a pump pressure corresponding to each of one or more nozzles according to the spraying rate of the each of one or more nozzles, or adjusting a pump speed corresponding to each of one or more nozzles according to the spraying rate of the each of one or more nozzles.

For example, when the spraying rate of a nozzle is increased, then the pump pressure corresponding to the nozzle is increased, or the pump speed corresponding to the nozzle is increased, or both the pump speed and the pump pressure corresponding to the nozzle are increased simultaneously. When the spraying rate of the nozzle is reduced, then the pump pressure corresponding to the nozzle is reduced, or the pump speed corresponding to the nozzle is reduced, or both the pump speed and the pump pressure corresponding to the nozzle are reduced simultaneously.

In some embodiments, if the operation member includes one or more distribution outlets, a distribution rate of each of one or more distribution outlets can be determined according to the linear speed of the each of one or more distribution outlets, and each of one or more distribution outlets can be controlled to perform an operation according to the distribution rate of each of one or more distribution outlets.

In some embodiments, controlling each of one or more distribution outlets to perform an operation according to the distribution rate of the each of one or more distribution outlets may include controlling each of one or more distribution outlets to perform an operation by at least one of adjusting a size of the each of one or more distribution outlets according to the distribution rate of each of one or more distribution outlets, or adjusting an opening angle of each of one or more distribution outlets according to the distribution rate of the each of one or more distribution outlets.

For example, when the distribution rate of a distribution outlet is increased, then the size of the distribution outlet is increased, or the opening angle of the distribution outlet is increased, or both the size and the opening angle of the distribution outlet are increased simultaneously. When the distribution rate of the distribution outlet is reduced, then the size of the distribution outlet is reduced, or the opening angle of the distribution outlet is reduced, or both the size and the opening angle of the distribution outlet are reduced simultaneously.

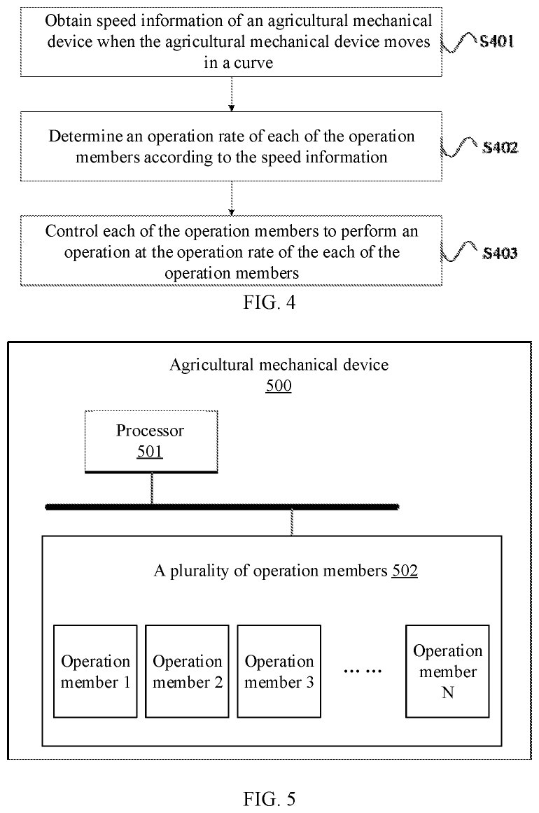

FIG. 4 a schematic flow chart of a control method for an agricultural mechanical device according to another example embodiment of the disclosure. The method can be used to control an agricultural mechanical device to perform an agricultural operation. The agricultural mechanical device may be provided with a plurality of operation members, and the plurality of operation members are located at different positions in a direction perpendicular to a moving direction of the agricultural mechanical device. As shown in FIG. 4, the control method for an agricultural mechanical device includes following processes.

At S401, speed information of the agricultural mechanical device is obtained when the agricultural mechanical device moves in a curve.

At S402, an operation rate of each of the operation members is determined according to the speed information.

At S403, each of the operation members is controlled to perform an operation at the operation rate of the each of the operation members.

In some embodiments, the speed information may include at least one of an angular speed or a linear speed.

In some embodiments, the speed information may be measured by a motion sensor, and the motion sensor may be mounted at the agricultural mechanical device. The motion sensor may include at least one of an IMU, an angular speed sensor, or a linear speed sensor.

In some embodiments, when the agricultural mechanical device moves in a curve, the operation rate of each of the operation members is different from each other. When the agricultural mechanical device moves in a curve, the linear speed of each of the operation members is different from each other, and an operation area per unit time of each of the operation members is different from each other. Therefore, the operation rate of each of the operation members is different from each other to achieve a uniform operation.

In some embodiments, the operation rate of each of the operation members is gradually changed according to the position of the each of the operation members in the direction perpendicular to the moving direction of the agricultural mechanical device.

In an example embodiment, after the operation rate of each of the operation members is determined, each of the operation members is controlled to perform an operation at the operation rate thereof. For example, the operation rate can be controlled by one or more of controlling a pump speed, controlling a pump pressure, controlling a pump throttle, controlling a size of a distribution outlet, and controlling an opening angle of a distribution outlet.

In the control method for an agricultural mechanical device consistent with the embodiments, the speed information of the agricultural mechanical device is obtained when the agricultural mechanical device moves in a curve. The operation rate of each of the operation members is determined according to the speed information. Each of the operation members is controlled to perform an operation according to the operation rate of the each of the operation members at the operation rate thereof, which realizes that the operation rate of each of the operation members is adaptively adjusted, and improves operation uniformity of the agricultural mechanical device when the agricultural mechanical device moves in a curve.

In summary, in the control method for an agricultural mechanical device consistent with the embodiments of the present disclosure, the operation rate of each of the operation members can be determined according to the linear speed of the each of the operation members, to realize that the operation rate of each of the operation members is adaptively adjusted according to the linear speed of the each of the operation members, thereby improving the operation uniformity of the agricultural mechanical device when the agricultural device moves in a curve, and preventing the agricultural mechanical device from slowing down or stopping the operation even if the agricultural mechanical device encounters a 90-degree or even a 180-degree turn during the operation, which improves the operate efficiency.

FIG. 5 is a schematic structural diagram of an example agricultural mechanical device 500 according to an embodiment of the disclosure. As shown in FIG. 5, the agricultural mechanical device 500 includes a processor 501 and a plurality of operation members 502. The processor 501 and the plurality of operation members 502 are communicatively connected through a bus. The plurality of operation members 502 include operation member 1, operation member 2, operation member 3, . . . , operation member N. The total number of the operation members is N, where N is an integer greater than or equal to 2. The processor 501 may include a central processing unit (CPU), or may include another general-purpose processor, a digital signal processor (DSP), an application specific integrated circuit (ASIC), a field-programmable gate array (FPGA), or another logic device, such as a programmable logic device, a discrete gate or transistor logic device, or a discrete hardware component, etc. The general-purpose processor may include a microprocessor or another conventional processor, etc.

The plurality of operation members 502 are located at different positions in a direction perpendicular to a moving direction of the agricultural mechanical device 500.

The processor 501 is configured to execute a computer program to obtain a linear speed of each of the operation members 502 of the agricultural mechanical device 500 when the agricultural mechanical device 500 moves in a curve, determine an operation rate of each of the operation members 502 according to the linear speed of the each of the operation members 502, and control each of the operation members to perform an operation according to the operation rate of the each of the operation members 502.

In some embodiments, the processor 501 is specifically configured to execute a computer program to obtain the linear speed of each of the operation members 502 of the agricultural mechanical device 500 according to a preset operation route and current position information of the agricultural mechanical device 500.

In some embodiments, the processor 501 is specifically configured to execute a computer program to determine a turning radius of the agricultural mechanical device 500 according to the preset operation route and the current position information of the agricultural mechanical device 500, and obtain the linear speed of each of the operation members 502 of the agricultural mechanical device 500 according to the turning radius and a current moving speed of the agricultural mechanical device 500, and a distance of the each of the operation members 502 from a central axis of the agricultural mechanical device 500.

In some embodiments, the processor 501 is specifically configured to execute a computer program to determine an angular speed of the agricultural mechanical device 500 according to the turning radius and the current moving speed of the agricultural mechanical device 500, determine the turning radius of each of the operation members 502, and obtain the linear speed of each of the operation members 502 of the agricultural mechanical device 500 according to the turning radius of the each of the operation members 502 and the angular speed of the agricultural mechanical device 500.

In some embodiments, the processor 501 is specifically configured to execute a computer program to obtain attitude information of the agricultural mechanical device 500 and obtain the linear speed of each of the operation members 502 of the agricultural mechanical device 500 according to the attitude information.

In some embodiments, the processor 501 is specifically configured to execute a computer program to determine the angular speed and turning radius of the agricultural mechanical device 500 according to the attitude information, and obtain the linear speed of each of the operation members 502 of the agricultural mechanical device 500 according to the angular speed and turning radius of the agricultural mechanical device 500 and the distance of the each of the operation members 502 from the central axis of the agricultural mechanical device 500.

In some embodiments, the processor 501 is specifically configured to execute a computer program to determine the operation rate of each of the operation members 502 according to the linear speed of the each of the operation members 502 and a preset corresponding relationship between the linear speed and the operation rate.

In some embodiments, the operation rate of each of the operation members 502 is positively related to the linear speed of the each of the operation members 502.

In some embodiments, the processor 501 is specifically configured to execute a computer program to determine a linear speed ratio among the operation members 502 according to the linear speed of the each of the operation members 502, and determine the operation rate of each of the operation members 502 according to the linear speed ratio among the operation members 502.

In some embodiments, the processor 501 is specifically configured to execute a computer program to determine the operation rate of each of the operation members 502 according to the linear speed ratio among the operation members 502 and a total operation rate of the agricultural mechanical device 500.

In some embodiments, the operation member 502 includes a nozzle and/or a distribution outlet.

In some embodiments, if the operation members 502 include a plurality of nozzles, the processor 501 is specifically configured to execute a computer program to determine a spraying rate of each of the nozzles according to the linear speed of the each of the nozzles, and control each of the nozzles to perform an operation according to the spraying rate of the each of the nozzles.

In some embodiments, the processor 501 is specifically configured to execute a computer program to control each of the nozzles to perform an operation by at least one of adjusting a pump pressure corresponding to each of the nozzles according to the spraying rate of the each of the nozzles or adjusting a pump speed corresponding to each of the nozzles according to the spraying rate of the each of the nozzles.

In some embodiments, if the operation members 502 include a plurality of distribution outlets, the processor 501 is specifically configured to execute a computer program to determine a distribution rate of each of the distribution outlets according to the linear speed of the each of the distribution outlets, and control each of the distribution outlets to perform an operation according to the distribution rate of the each of the distribution outlets.

In some embodiments, the processor 501 is specifically configured to execute a computer program to control each of the distribution outlets to perform an operation by at least one of adjusting a size of each of the distribution outlets according to the distribution rate of the each of the distribution outlets or adjusting an opening angle of each of the distribution outlets according to the distribution rate of the each of the distribution outlets.

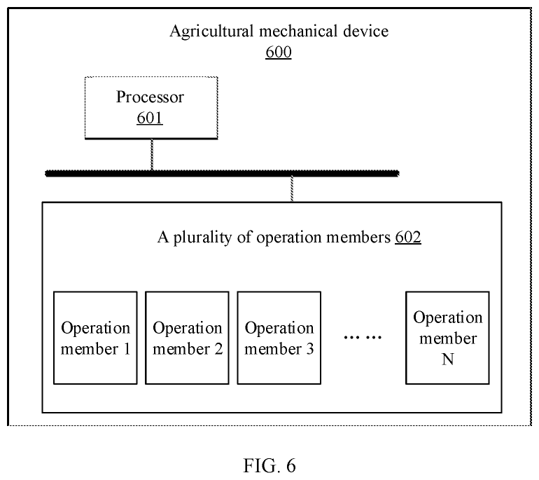

FIG. 6 is a schematic structural diagram of another example agricultural mechanical device according to another embodiment of the disclosure. As shown in FIG. 6, the agricultural mechanical device 600 includes a processor 601 and a plurality of operation members 602. The processor 601 and a plurality of operation members 602 are communicatively connected through a bus. The plurality of operation members 602 include operation member 1, operation member 2, operation member 3, . . . , operation member N. The total number of the operation members is N, where N is an integer greater than or equal to 2. The processor 601 may include a central processing unit (CPU), or may include another general-purpose processor, a digital signal processor (DSP), an application specific integrated circuit (ASIC), a field-programmable gate array (FPGA), or another logic device, such as a programmable logic device, a discrete gate or transistor logic device, or a discrete hardware component, etc. The general-purpose processor may include a microprocessor or another conventional processor, etc.

The plurality of operation members 602 are located at different positions in a direction perpendicular to a moving direction of the agricultural mechanical device 600.

The processor 601 is configured to execute a computer program to obtain speed information of the agricultural mechanical device 600 when the agricultural mechanical device 600 moves in a curve, determine the operation rate of each of the operation members 602 according to the speed information, and control each of the operation members 602 to perform an operation at the operation rate of the each of the operation members 602.

In some embodiments, the speed information includes at least one of an angular speed or a linear speed.

In some embodiments, the speed information is measured by a motion sensor, and the motion sensor is mounted at the agricultural mechanical device 600.

In some embodiments, the motion sensor includes at least one of an IMU, an angular speed sensor, or a linear speed sensor.

In some embodiments, when the agricultural mechanical device 600 moves in a curve, the operation rate of each of the operation members 602 is different from each other.

In some embodiments, the operation rate of each of the operation members 602 is gradually changed according to the position of the each of the operation members 602 in the direction perpendicular to the moving direction of the agricultural mechanical device 600.

A control device (such as a chip, an integrated circuit, etc.) for an agricultural mechanical consistent with embodiments of the present disclosure includes a memory and a processor. The memory stores a code for executing a control method for an agricultural mechanical device. The processor is configured to execute the code stored in the memory to execute the control method for an agricultural mechanical device described in any of the above method embodiments. The control device for an agricultural mechanical device can be applied to an agricultural mechanical device, such as an agricultural UAV, an agricultural robot, an agricultural ground mechanical device, etc., to control the agricultural mechanical device to perform an agricultural operation.

A person of ordinary skill in the art can understand that all or part of the processes in the above method embodiments can be implemented by a program instructing relevant hardware. The program can be stored in a computer readable storage medium. When the program is executed, the processes included in the method embodiments are executed. The storage medium can be any medium that can store program codes, such as a read-only memory (ROM), a random-access memory (RAM), a magnetic disk, or an optical disk, etc.

Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. A control method comprising:
obtaining a linear speed of one operation member of a plurality of operation members of an agricultural mechanical device when the agricultural mechanical device is making a curvilinear movement, the plurality of operation members being located at different positions in a direction perpendicular to a moving direction of the agricultural mechanical device;
determining an operation rate of the one operation member according to the linear speed of the one operation member; and
controlling the one operation member to perform an operation according to the operation rate of the one operation member.

2. The method of claim 1, wherein obtaining the linear speed of the one operation member when the agricultural mechanical device is making a curvilinear movement includes:
obtaining the linear speed of the one operation member according to a preset operation route and current position information of the agricultural mechanical device.

3. The method of claim 2, wherein obtaining the linear speed of the one operation member according to the preset operation route and the current position information of the agricultural mechanical device includes:
determining a turning radius of the agricultural mechanical device according to the preset operation route and the current position information of the agricultural mechanical device; and
obtaining the linear speed of the one operation member according to the turning radius and a current moving speed of the agricultural mechanical device, and a distance between the one operation member and a central axis of the agricultural mechanical device.

4. The method of claim 3, wherein obtaining the linear speed of the one operation member according to the turning radius and the current moving speed of the agricultural mechanical device, and the distance between the one operation member and the central axis of the agricultural mechanical device includes:
determining an angular speed of the agricultural mechanical device according to the turning radius and the current moving speed of the agricultural mechanical device;
determining a turning radius of the one operation member according to the turning radius of the agricultural mechanical device and the distance between the one operation member and the central axis of the agricultural mechanical device; and
obtaining the linear speed of the one operation member according to the turning radius of the one operation member and the angular speed of the agricultural mechanical device.

5. The method of claim 1, wherein obtaining the linear speed of the one operation member when the agricultural mechanical device is making a curvilinear movement includes:
obtaining attitude information of the agricultural mechanical device; and
obtaining the linear speed of the one operation member according to the attitude information of the agricultural mechanical device.

6. The method of claim 5, wherein obtaining the linear speed of the one operation member according to the attitude information includes:
determining an angular speed and a turning radius of the agricultural mechanical device; and
obtaining the linear speed of the one operation member according to the angular speed and the turning radius of the agricultural mechanical device, and a distance between the one operation member and a central axis of the agricultural mechanical device.

7. The method of claim 1, wherein determining the operation rate of the one operation member according to the linear speed of the one operation member includes:
determining the operation rate of the one operation member according to a preset corresponding relationship between the linear speed and the operation rate.

8. The method of claim 1, wherein the operation rate of the one operation member is positively related to the linear speed of the one operation member.

9. The method of claim 1, wherein determining the operation rate of the one operation member according to the linear speed of the one operation member includes:
determining a linear speed ratio among the plurality of operation members according to a linear speed of each of the plurality of operation members; and
determining the operation rate of the one operation member according to the linear speed ratio.

10. The method of claim 9, wherein determining the operation rate of the one operation member according to the linear speed ratio includes:
determining the operation rate of the one operation member according to the linear speed ratio and a total operation rate of the agricultural mechanical device.

11. The method of claim 1, wherein each of the plurality of operation members includes at least one of a nozzle or a distribution outlet.

12. The method of claim 11, wherein:
the plurality of operation members include a plurality of nozzles;
determining the operation rate of the one operation member according to the linear speed of the one operation member includes:
determining a spraying rate of one nozzle of the plurality of nozzles according to the linear speed of the one nozzle; and
controlling the one operation member to perform the operation according to the operation rate of the one operation member includes:
controlling the one nozzle to perform the operation according to the spraying rate of the one nozzle.

13. The method of claim 12, wherein controlling the one nozzle to perform the operation according to the spraying rate of the one nozzle includes performing at least one of:
adjusting a pump pressure corresponding to the one nozzle according to the spraying rate of the one nozzle; or
adjusting a pump speed corresponding to the one nozzle according to the spraying rate of the one nozzle.

14. The method of claim 11, wherein:
the plurality of operation members include a plurality of distribution outlets;
determining the operation rate of the one operation member according to the linear speed of the one operation member includes:
determining a distribution rate of one distribution outlet of the plurality of distribution outlets according to the linear speed of the one distribution outlet; and
controlling the one operation member to perform the operation according to the operation rate of the one operation member includes:
controlling the one distribution outlet to perform the operation according to the distribution rate of the one distribution outlet.

15. The method of claim 14, wherein controlling the one distribution outlet to perform the operation according to the distribution rate of each of the one distribution outlet includes performing at least one of:
adjusting a size of the one distribution outlet according to the distribution rate of the one distribution outlet; or
adjusting an opening angle of the one distribution outlet according to the distribution rate of the one distribution outlet.

16. A control method comprising:
obtaining speed information of the agricultural mechanical device making a curvilinear movement;
determining operation rates of a plurality of operation members of the agricultural mechanical device according to the speed information, the plurality of operation members being located at different positions in a direction perpendicular to a moving direction of the agricultural mechanical device; and
controlling the plurality of operation members to perform operations at the operation rates of the plurality of operation members.

17. The method of claim 16, wherein the speed information includes at least one of an angular speed or a linear speed.

18. The method of claim 16, wherein the speed information is measured by a motion sensor mounted at the agricultural mechanical device.

19. The method of claim 18, wherein the motion sensor includes at least one of an inertial measurement unit (IMU), an angular speed sensor, or a linear speed sensor.

20. The method of claim 16, wherein the operation rates of the plurality of operation members are different from each other when the agricultural mechanical device is making the curvilinear movement.
